(19) United States
(12) Patent Application Publication
(10) Pub. No.: US 2004/0114888 A1
(43) Pub. Date: Jun. 17, 2004

(54) Multi-function security cable with optic-fiber sensor

(76) Inventors: Brian Gerald Rich, Kanata (CA); William John Evenson, Mountain View, CA (US)

Correspondence Address: SHAPIRO COHEN, P.O. BOX 3440, STATION D, OTTAWA, ON, K1P6P1, CA

(21) Appl. No.: 10/673,481

(22) Filed: Sep. 30, 2003

Related U.S. Application Data
(63) Continuation-in-part of application No. 10/266,696, filed on Oct. 9, 2002.

(51) Int. Cl. G02B 6/44

(52) U.S. Cl. 385/101

(57) ABSTRACT

A multi-function security cable is disclosed for use as a perimeter security cable for an intrusion detection system, a secure communications cable, and a secure power cable. The security cable includes an optical fiber sub-cable, a communications sub-cable, and a pair of power conductors combined within an overjacket. A central filler is provided for strength to the perimeter security cable, and strength members and a central filler are provided between and adjacent to the sub-cables and within the overjacket for providing a strong and tight structure.

### RELATED APPLICATIONS

This patent Application is a Continuation-in-Part of the U.S. patent application Ser. No. 10/266,696 (Rich et al.), “Fiber optic security sensor and system with integrated secure data transmission and power cables”, filed Oct. 9, 2002.

### BACKGROUND OF THE INVENTION

1. Field of Invention

The present invention relates to a security cable and particularly to a perimeter security cable with integrated data communications and power distribution capabilities.

2. Discussion of the Prior Art

Security sensor cables are often deployed along the periphery of an area of interest and connected to complex intrusion detection systems that process the signals received from the sensor cable and detect changes produced by disturbances in proximity to the sensor. Such cables are deployed in the ground about the perimeter, or for example attached to a perimeter fence, in order to detect someone crossing the perimeter. In the field of security sensor systems, outdoor sensors face challenges not found in indoor security situations. The outdoor sensors must be sensitive enough to enable the respective security system to sense an intrusion, and must be resilient enough to environmental conditions, such as temperature extremes, rain, snow, damage caused by animals, blowing debris, . . . etc. When functioning under these adverse conditions, the sensor must continue to maintain a high probability of intrusion detection.

Some intrusion detection systems must satisfy certain specific environmental characteristics. Thus, intrusion detection systems for power stations or communication centers must not only have a high probability of detection, they also must be designed to operate in an intense electromagnetic field environment, and with minimum electromagnetic disturbance to other on-site power generation, transmission, or communication equipment.

In general, security sensor cables within perimeter security systems have a limited length such that intrusion detection systems for large areas often require plural sensors and anywhere from 2 to as many as 20 intermediate processing units operating under control of a central processor. Along the perimeter of such a system, there may be cable fence detection zones delineated along a section of fence length that ranges from 50 m to as much as 2000 m per section. Also, in many cases, the processing units operate local video cameras. Such cameras capture visual images of intrusion events within a given zone along the perimeter. The zone lengths are selected to match the perimeter and video assessment ranges usually under 100 m. The electronics at the intermediate processing units, the cameras, and other electrical appliances that may be present at the intermediate sites (lights, microwave sensors at gates . . . etc) must be power supplied in order to operate. This is more relevant because the fences/walls of most areas to be secured are in remote locations where power is not readily available.

It is understood that intrusion detection systems require a power network, for power supplying intermediate processing units, cameras, and any other electrical appliances used by such system from the central processor or a power access point. This power network is normally buried or mounted on structures either shared or separate from the sensor cables of the detection system while running in parallel with the sensor cables As such, the power cables require installation following a specified protocol to ensure longevity and security.

Furthermore, in many instances, control data is transmitted from the central processor to the intermediate processing units, and measurements and reports are transmitted from the intermediate processing units to the central processing unit. More typically, the intermediate units are the networked field processors, while the central processing unit is more a collector for control and display of alarms. Therefore, most intrusion detection systems require a (data) network for carrying data/control signals between the intermediate processing units and the central processor. The cable(s) carrying this information are installed along the same path, or not, with the security sensor cable, and mounted for security and longevity, for example in conduit at the top of the fence on which the sensor cable is deployed.

There is a need to integrate the security sensor cable with the data cable(s) and the power supply cable, to obtain important savings in labour and equipment and provide security to the power and data communications. Cost saving are provided by replacing three (or more) environmentally resilient cables with one. It is also less expensive to deploy one integrated cable than three or more separate cables. Also, there is no need to provide separate means for detecting a cable malfunction, tampering or cut for three or more different cables.

Currently, the sensor cables detect intrusion by detecting a change in the surrounding environment to which the cables are coupled.

Thus, some intrusion detection systems use leaky coaxial cables deployed around the perimeter of interest and an RF excited antenna radiates energy within the area to be protected. The presence of an intruder alters the coupling between the antenna and the cable thereby changing the signal received from the cable. The detection system is responsive to incremental changes in the in-phase and quadrature components of the received signal. Alternatively, a pair of leaky cables may be used, one for producing an lectromagnetic field of RF energy and the second cable, arranged alongsid the first, for sensing the electromagnetic field produced. The presence and position of an intruder with respect to the cable may be detected by selecting the parameters (frequency, type, intensity, shape) of the RF signal, and by interpreting the parameters (intensity, phase) of the received signal.

Buried pressure-tube cables are also used within intrusion detection systems. However, these can be ineffective in cold climates due to the penetration of frost.

Also, such seismic sensors are prone to nuisance alarms due to vibrations from remote activities such as vehicular traffic.

Some security systems rely upon the change of capacitance between two sensing wires. Others rely upon the change of impedance of a two-wire transmission line due to the presence of an intruder. Most of these systems have relatively poor sensitivity because they attempt to detect very small changes in a large quantity, which usually is a function of the physical deployment of the sensor. This can result in false alarms because of vibration, rain, snow, or variations in temperature and humidity.

There is also a need to provide a sensor cable as part of a security sensor system that provides reliable intrusion detection, while discriminating between a real and a nuisance alarm. It should be noted that a nuisance alarm is real input like an animal climbing on the fence, and a false alarm is no observable cause, like an electronic upset.

In addition to providing a single cable for the power and data distribution component of the perimeter security sensor system, there are other applications where the security of the distribution of power or data in a network is of paramount importance. In such instances, the sensing fib r is integrated with the power and data cables in a cable optimized for the security of either or both of th se functions, rather than just for perimeter security of the structure on which it is mount d.

### SUMMARY OF THE INVENTION

The present invention provides a perimeter security cable for an intrusion detection system that integrates a security sensor cable with a power distribution cable and one or more data transmission cables. Such a perimeter security cable long with a signal processing means forms a “sensor” and may be referred to as a “systern” for sensing. Such a perimeter security cable is optic-fiber based and can be advantageously used within intrusion detection systems due to the sensitivity of the fiber to vibrations or mechanical deformations.

The present invention also provides a security cable for an intrusion detection system comprising: an optical fiber sub-cable for carrying an optical signal having terminations at a source and a detector of a processor; a communications sub-cable for providing data communications; a pair of power conductors for distributing power; an overjacket for encasing said first optical fiber sub-cables and said pair of power conductors; a central filler for providing strength to said perimeter security cable; and strength members provided between said central filler and said overiacket for providing a tight structure to said security cable; wherein local vibrations of said optical fiber sub-cable by an intrusion produce an optical parameter change so as to enable detection along the length of said security cable by said processor.

Still further, the present invention provides such a security cable wherein said data communications are for both said intrusion detection system and a communications system external to said intrusion detection system, said pair of power conductors are for distributing power to both said intrusion detection system and external to said intrusion detection system, and said security cable serves to provide for combined power distribution, secure communications, and perimeter security.

Advantageously, the integrated perimeter security sensor cable according to the invention provides important savings in labour and equipment. Further, the present invention is resistant to electromagnetic interference (EMI) such as lightning, nearby power substations, or communications and radio transmission sites. The present invention exhibits low signal loss with distance and enables long zones between processors or multiple passes for tall fences. The present invention includes consistent cable properties with length from high volume commercial manufacturing. The present invention is tamper-resistant such that it is difficult to receive or inject signals remotely like radio frequency systems—e.g., jamming. Further, the present invention forms an acoustic/microphonic cable sensor in that it responds to vibrations, but compared to other microphonic sensors, (e.g., triboelectric, magnetic, loose-conductor impedance cables, . . . etc.) has no loose mechanical conductors.

The integrated perimeter security sensor cable of the invention has superior moisture and mechanical protection characteristics provided by multiple buffers and advanced jacket design providing superior moisture resistance, ultraviolet resistance, material durability, and extended temperature range, making it suitable for outdoor runs.

### BRIEF DESCRIPTION OF THE DRAWINGS

FIG. 1 is a cross-section of the security sensor cable according to one embodiment of the invention.

FIG. 2 is a cross-section of the security sensor cable according to another embodiment of the invention.

### DETAILED DESCRIPTION

The invention will be described for the purposes of illustration only in connection with certain embodiments; however, it is to be understood that other objects and advantages of the present invention will be made apparent by the following description of the drawings according to the present invention While preferred embodiments are disclosed, this is not intended to be limiting. Rather, the general principles set forth herein are considered to be merely illustrative of the scope of the present invention and it is to be further understood that numerous changes may be made without straying from the scope of the present invention.

The perimeter security cable according to the invention can be used within a variety of sensors and systems without straying from the intended scope of the present invention. One such sensor is IntelliFIBER™, a fiber-optic based fence-disturbance sensor for outdoor perimeter security applications from Senstar-Stellar Corp., of Carp, Ontario, Canada. In such a sensor, intrusion detection is based on the ability of the fiber to change its transmission characteristics in response to a mechanical disturbance created by an intruder. Sensors such as IntelliFIBER™ provide no location and operate in transmission only (i.e., not in reflection). Moreover, sensors such as lntelliFIBER™ in the field of fiber optic security equipment currently include polarmetric multimode fiber optic sensors that rely on the differential coupling of light between polarisation states within a multimode optical fiber.

When a disturbance occurs along the length of a multimode optical fiber, coupling between both the spatial modes propagating within the fiber and the polarisation eigenstates occur. Such fiber optic sensors use a multimode continuous wave laser diode The system is operated in transmission. Polarized light is launched by a pigtailed laser diode into a multimode sensor fiber. When the fiber is disturbed, light is coupled between the s- and p-polarisation states. The frequency and strength of the coupling is dependent upon the frequency and strength of the disturbance. The s-and p-polarisation states are defined by the orientation of the plane-of-incidence of the polarisation beam splitter (PBS) cube. Transmitted light is emitted from the fiber at a collimator and into the s-and p-polarisation exit ports of the PBS cube. Light from the PBS cube is then detected on pin silicon photodiodes by p-state and s-state detectors. The difference in the output voltages of the pin silicon photodiodes is dependent upon the disturbance such that the difference is processed to identify an intrusion.

The present inventive perimeter security cable is also useful within in other fiber optic sensors including, but not limited to, such sensors and systems that use the redistribution of the energy in the spatial modes on a multimode fiber to detect a disturbance to the fiber. Examples of such include U.S. Pat. No. 5,144,689 issued to Lovely on Sep. 1, 1992 and PCT Publication WO9608695 filed by Tapanes on May 28, 1997. In operation, the present inventive perimeter security cable can use single or multimode fibers depending upon the sensing or communications methodology utilized.

The present inventive perimeter security cable may be deployed as a number of discrete cable lengths and tie-wrapped to the perimeter fence and connected to intermediate processors. Because the inventive cable operates in transmission, either the two ends of the fiber must be accessible to the same processor (e.g., a cable in a loop on the fence, or the cable runs between a transmitter on one processor and the receiver of the adjacent processor) or two fibers within the same inventive cable are fused at the end opposite to the processor. The loop is normally deployed for high fences to provide cable “passes” at two heights to give better detection.

In systems using the inventive cable, processed signals or alarm data at each processor are normally communicated to a head-end controller via either twisted pair copper (not shown) or optical fibers (such as those found in the FIG. 2) for network communications that run within the inventive cable in a ring between the intermediate processors. Various numbers of twisted pair copp r or optical fibers and related topologies can be used d pending upon protocols and redundancy in case of single point failures. All fiber connections are normally made by standard fiber connectors at the processor, and field connections either by connectors or fusion splicing.

In systems using the inventive cable, power is distributed to each processor, again by multi-conductor, copper conductors around the perimeter, contained within the inventive cable and connected from the central supply to each processor via terminal strips.

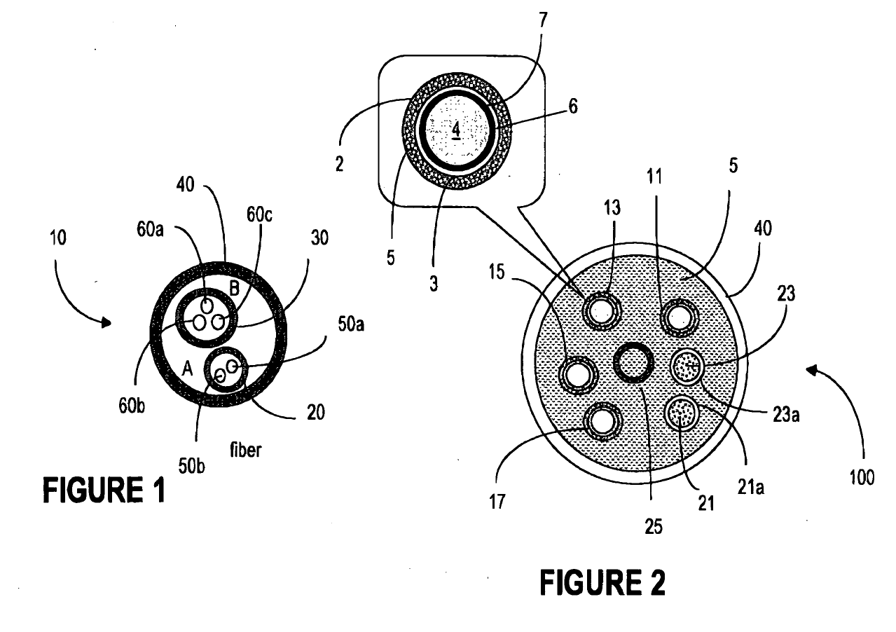

With reference to the figures, there is shown in FIG. 1 a cross-section of the perimeter security sensor cable according to the present invention. The embodiment shown in FIG. 1 corresponds to the embodiment illustrated in FIG. 2 of the above-identified parent patent application herein incorporated by reference; the same reference numerals are used in this description.

In FIG. 1, the sensor cable 10 includes an overjacket 40 in which two sub-cables A and B are positioned collinearly, or coaxially. Each sub-cable A, B has in turn a respective primary jacket 20 and secondary jacket 30. Jacket 20 houses two fiber optic cables 50a and 50b. While only two fiber optic cables 50a, 50b are shown, the skilled artisan will understand that the fiber optic cables may be in the form of cabling bundles with multiple individual fibers in the primary jacket 20, or fiber optic cable ribbon, or the like. At least one of the two fiber optic cables, e.g., 50a, is used as a sensor.

As indicated above, the fiber-optic cable 50a carries an optical signal of known parameters (e.g., a sensing signal). Such parameters change when an attempt is made to cut, climb, lift, or otherwise disturb the fence fabric to which it is attached for example, or more particularly to disturb the security sensor cable 10. It should be noted that both cables 50a and 50b may be used as sensors. Also, both cables 50a and 50b may in addition be used for transmitting information such as control signals, measurements, alarms, . . . etc, multiplexed with the sensing signal(s), as is well understood in the art of signal processing. Still further, some applications may use more than two fiber-optic cables, as would be apparent to a person skilled in the art.

Sub-cable B may house two or more power conductors 60a, 60b, and one or more cables used for data transmission 60c, or may house solely a plurality of power conductor cables.

The overjacket 40 according to the present invention can be fabricated from materials, such as polyethylene, polyvinyl chloride, or stainless steel, or any similarly suitable waterproof layer. For outdoor applications, the overjacket would include ultraviolet protective materials or process additives. The diameter of the overjacket 40 depends on the intrusion security system that uses this inventive cable. The given intrusion security system that uses this inventive cable also dictates, for example, the number of sub-cables or conductors and the number of the data transmission fibers. The wall thickness of the overjacket 40 depends on the environmental wear and tear of a particular application and materials used, for example to prevent water penetration, and provide cut or tear resistance. Preferably, the overjacket 40 is tightly fitted around jackets 20, 30 by any method or manner such as, but not limited to, extrusion or heat shrinking depending upon the material used, or may contain tensile or filler members such as Kevlar™ fibers from DuPont of Wilmington, Del, USA. Such fibers consist of long molecular chains produced from poly-paraphenylene terephthalamide that are highly oriented with strong interchain bonding which result in a unique combination of properties. It should be understood that there may be fillers or tensile members intermediate to the ovedacket and A and B.

If the sensor system were intended for underground applications, the overjacket 40 would require a waterproof layer. A cut or rodent resistant layer may be provided as part of overjacket 40 for th case when perimeter security cable 10 is buried, or partly buried in the ground or on a given structure.

The fiber optic cables 50a, 50b may be standard commercial fiber optic cables.

FIG. 2 shows another embodiment of the perimeter security cable 100 according to the invention. In this example, sub-cables A and B are not used as such, eliminating the primary and secondary jackets 20, 30; rather all cables are enclosed in an overjacket 40. Sub-cables 11, 13, 15 and 17 are optic-fiber based, and conductors 21, 23 are used for power distribution

A central filler 25 is used to give strength to the inventive cable 100 and to obtain a tight assembly, and any suitable filler material may be used. Preferably, the space between the sub-cables is filled with yam strength members, as shown at 5. These yams may be super-absorbent polymer coated yarns for strength, and for isolating the sub-cables from the outside humidity and for limiting the movement of the sub-cables inside the overjacket.

Preferably, four fiber-optic sub-cables 11, 13, 15 and 17 are housed in jacket 40 Typically one or two of sub-cables 11, 13, 15, and 17 are used for sensing an intrusion, and the remainder may be used for communications (measurements, control, video, and audio information, . . . etc.) For example with IntelliFIBER, if there is a single pass of the cable on a fence, the ends of two sensing fibers 11, 13 remote from the processor can be fused together, and connectors installed at the processor end of the same fibers to connect to the processor sensor transmit output and receive inputs. The remaining two fibers 15, 17 (of the four) would be similarly connected at each end to the transmit and receive data communications ports of the adjacent processor to provide data communications as part of a network (not shown). Because the data is normally communicated in a ring topology, this may require a similar connection of the two fibers to the matching fibers of the adjacent zone cables to provide a continuous data communications path. In other cases dependent on the application, few r or more fibers may be used, with as few as one if some multiplexing method is employed. However this generally is more costly and provides no path redundancy. Generally, th sensing fibers do not extend beyond their own detection zone and that part extended is made insensitive, whereas the power and data cables run between processors. Use of this cable in conjunction with various manufacturer's sensors and systems may require greater or fewer fibers.

The insert to FIG. 2 shows a cross-section of sub-cable 13 according to the second embodiment of the invention. Thus, an outer jacket 2 and an inner jacket 3 are provided for protecting the fiber 4, which is placed within the inner jacket 3. For implementation purposes, the outer jacket 2 may be color-coded. The space between jackets 2 and 3 is filled with a spacing material 5. Such spacing material 5 should preferably have characteristics including no melting point; low flammability; good fabric integrity at elevated temperatures such as Aramid Fiber. Aramid Fiber is a manufactured fiber in which the fiberforming substance is a long-chain synthetic polyamide in which at least 85% of the amide (—CO—NH—) linkages are attached directly between two aromatic rings. Aramid fiber is spun as a multifilament by a proprietary process developed by DuPont Company of Wilmington, Del., USA. Para-aramid fibers, which have a slightly different molecular structure, also provide outstanding strength-to-weight properties, high tenacity and high modulus.

In the preferred embodiment of the present invention (i.e., perimeter security applications), the spacing material 5 is loosely arranged such that fiber movement is enhanced to thereby increase overall sensitivity of the sensing cable 100. In altemative applications, such as power cable applications or data security applications where someone would be directly attacking the sensing cable itself rather than a perimeter fence upon which the sensing cable 100 is mounted, the spacing material 5 may be more tightly packed. In such alternative applications it is important to detect tamp ring of the cable anywhere along its length by someone trying to subvert the power or communications. The cable in this case is deployed not necessarily on a perimeter, but rather following a route between for example the power source and the load (e.g., through a building, in conduit, aerial buried, . . . etc), with the detection system processing electronics located along the cable as suitable. It should be understood that the power conductors and or data fibers are sized or in quantity primarily for the intended loads, and the sensing fiber, power conductors, and data communications fibers for the detection function are secondary. It should be readily apparent that such alternative applications are optimized to detect tampering specifically with the cable itself, and not necessarily its environment.

Within the inner jacket 3 and exterior to the fiber 4 is a loose tube 6 which may affect the parameters of the sensing cable 100. The fiber 4 itself may have a primary buffer 7 such as an acrylate coating as shown

The conductors 21 and 23 are used to supply power to a respective intermediate processing unit (not shown). The conductors 21 and 23 include a plurality of wire strands, for flexibility, or are solid and sized according to the power to be conveyed, surrounded by a respective jacket 21a and 23a.

The inventive cables 10 and 100 may be constructed using materials such as a ripcord, or fiberglass strength members. The inventive cables 10 and 100 may use optical connectors for the optical fiber connections and electrical connectors for power conductor connections. Generally in a perimeter security application, the optical fibers for communications are spliced zone to zone, as well as power conductors, in a junction box at the end of the zone where optical sensing fiber is looped back into another optical fiber within the same zone. Alternatively, another cable 10, 100 would be utilized for perhaps two passes for a high fence along a protected perimeter. While signals may be multiplexed in few optical fibers, the number of fibers used may be incrementally increased with little impact on cost whereas multiplexing may complicate signal processing.

While a p rimet r security application is the preferred embodiment of the present invention, it should be understood that other applications are possible without straying from the scope of the intended invention. In the other applications of a secure power cable where the primary purpose of the cable is carrying power or a secure data cable where the primary purpose of the cable is carrying data there may of course be additional power or communications sub-cables as needed within the inventive cable. Relatedly, such sub-cables would typically terminate at given locations necessary to provide that function.

A person understanding the above-described invention may now conceive of alternative designs, using the principles described herein. All such designs that fall within the scope of the claims appended hereto are considered to be part of the present invention

What is claimed is:

1. A security cable for an intrusion detection system comprising:
an optical fiber sub-cable for carrying an optical signal having terminations at a source and a detector of a processor;
a communications sub-cable for providing data communications;
a pair of power conductors for distributing power;
an overjacket for encasing said first optical fiber sub-cables and said pair of power conductors;
a central filler for providing strength to said perimeter security cable; and
strength members provided between said central filler and said overjacket for providing a tight structure to said security cable;
wherein local vibrations of said optical fiber sub-cable by an intrusion produce an optical parameter change so as to enable detection along the length of said security cable by said processor.

2. The security cable as claimed in claim 1 wherein said data communications are for a communications system external to said intrusion detection system and said security cable serves primarily to provide for secure communications.

3. The security cable as claimed in claim 1 further including an additional optical fiber sub-cable for accommodating additional communications and said security cable serves primarily to provide for secure communications.

4. The security cable as claimed in claim 1 wherein said data communications are for said intrusion detection system and said security cable serves primarily to provide for perimeter security.

5. The security cable as claimed in claim 1 wherein said pair of power conductors are for distributing power to said intrusion detection system and said security cable serves primarily to provide for perimeter security.

6. The security cable as claimed in claim 1 wherein said pair of power conductors are for distributing power external to said intrusion detection system and said security cable serves primarily to provide for power distribution.

7. The security cable as claimed in claim 1 wherein said data communications are for both said intrusion detection system and a communications system external to said intrusion detection system and said security cable serves both to provide for secure communications and to provide for perimeter security.

8. The security cable as claimed in claim 1 wherein
said data communications are for both said intrusion detection system and a communications system external to said intrusion detection system,
said pair of power conductors are for distributing power to both said intrusion detection system and external to said intrusion detection system, and
said security cable serves to provide for combined power distribution, secure communications, and perimeter security.
